(19) United States
(12) Patent Application Publication
(10) Pub. No.: US 2005/0199587 A1
(43) Pub. Date: Sep. 15, 2005

(54) Non-chrome plating on plastic

(76) Inventor: Jon Bengston, West Hartford, CT (US)

Correspondence Address: John L. Cordani, Carmody & Torrance LLP, 50 Leavenworth Street, P.O. Box 1110, Waterbury, CT, 06721-1110, US

(21) Appl. No.: 10/799,018

(22) Filed: Mar. 12, 2004

(51) Int. Cl. B05D 3/04; C23C 18/30; C23C 18/24; B44C 1/22

(52) U.S. Cl. 216/83; 427/304; 106/1.05; 106/11; 252/79.1; 252/79.2; 216/96

(57) ABSTRACT

The invention comprises a process of preparing a non-conductive substrate for subsequent metalization. The process replaces the traditional chromic acid etching step with an etching solution comprising a permanganate and a mineral acid. The process also includes a novel activation solution comprising a palladium salt and an amine complexor. The new process of the invention is more environmentally friendly than the traditional chromic acid etching solutions but achieves a comparable result on most non-conductive substrates.

### FIELD OF THE INVENTION

This invention relates to a process for preparing a non-conductive substrate for subsequent metalization. The process uses a novel permanganate etching solution and a novel palladium activating solution for preparing the non-conductive substrate.

### BACKGROUND OF THE INVENTION

It is well-known in the art to plate non-conductive substrates, i.e., plastics, with metal for a variety of purposes. For example, metal plated plastics are used for decoration and for the fabrication of electronic devices. An example of a decorative use includes automobile parts such as trim. Examples of electronic uses include printed circuits, where the metal plated in a selective pattern comprises the conductors of the printed circuit board, and metal plated plastics used for EMI shielding. ABS resins are the most commonly plated plastics for decorative purposes while phenolic and epoxy resins are the most commonly plated plastics for the fabrication of printed circuit boards.

Preparing plastics for subsequent plating is a multi-step process. Typical steps of the process include:
1) Etching the substrate with a chromic acid etching solution;
2) Neutralizing the etched surface with a chrome neutralizing solution;
3) Activating the etched surface using a colloidal palladium tin activator;
4) Removing tin with an accelerating step; and
5) Depositing a layer of electroless copper or electroless nickel, followed by electrolytic copper and/or nickel plating.

In commercial practice, essentially all processes utilize a chromic acid etch solution as a source of hexavalent chromium for the plastic etching step. This process has many attributes. Various plastics including ABS and ABS/polycarbonate blends can be plated with good plate appearance and adhesion. Immersion time and/or temperature in the chromium etching solution can be increased to plate more difficult plastics containing higher levels of polycarbonate or polypropylene. Extremely difficult plastics that are etch resistant, such as pure polycarbonate, can be plated by incorporating a solvent prior to the chromium etching step.

The purpose of the etching step is two fold. First, the plastic is etched in such a fashion to increase surface area. Secondly, the plastic is made hydrophilic, making the surface receptive to subsequent activating and plating stages. Typical chromic acid etching solutions are found, for example, in U.S. Pat. No. 4,610,895 to Tubergen et al. and in U.S. Pat. No. 3,445,350 to Klinger et al., which are herein incorporated by reference in their entirety.

One problem with the traditional chromic acid etching step is that chromic acid is a recognized carcinogen and is increasingly regulated. The use of a chromic acid etchant has well-known and serious drawbacks, including the toxicity of chromium compounds which makes their disposal difficult; chromic acid residues remaining on the polymer surface that inhibit electroless deposition; and the difficulty of rinsing chromic acid residues from the polymer surface following treatment. Additionally, hot hexavalent chromium sulfuric acid solutions are naturally hazardous to workers. Burns and upper respiratory bleeding are common in workers routinely involved with chrome etch solutions. Thus, it is desired that safer alternatives to acidic chromium etching be developed.

For many years those skilled in the art have attempted to replace chromic acid with other oxidizing agents. One material proposed for replacing chromic acid is potassium permanganate, and the use of alkali permanganate solutions, has been investigated as a possible alternative to chromic acid etching. Hot alkaline permanganate solutions have seen some commercial success, but their success has been generally limited to treating printed circuit boards.

U.S. Pat. Nos. 4,610,895 to Tubergen et al. and 6,645,557 to Joshi, which are herein incorporated by reference in their entirety, describe various methods of forming a conductive metal layer on a non-conductive substrate. Tubergen et al. disclose the use of either hexavalent chromium or permanganate etching solutions with a further step of contacting the treated substrate with a reducing agent to reduce/remove the permanganate or hexavalent chromium remaining on the surface. Various reducing agents, including oxalates, aldehydes, formates, and hydrazine are suggested, with hydroxylamine being preferred.

U.S. Pat. No. 4,948,630 to Courduvelis et al., which is herein incorporated by reference in its entirety, describes a hot alkaline permanganate solution that also contains a material, such as sodium hypochlorite, that has an oxidation potential higher than the oxidation potential of the permanganate solution and is capable of oxidizing manganate ions to permanganate ions. U.S. Pat. No. 5,648,125 to Cane, which is herein incorporated by reference in its entirety, describes the use of an alkaline permanganate solution comprising potassium permanganate and sodium hydroxide, wherein the permanganate solution is maintained at an elevated temperature, i.e., between about 165° F. and 200° F. U.S. Pat. No. 4,042,729 to Polichette et al., which is herein incorporated by reference in its entirety describes an etching solution that comprises water, permanganate ion, and manganate ion, wherein the molar ratio of manganate ion to permanganate ion is controlled and the pH of the solution is maintained at 11-13.

U.S. Pat. No. 5,229,169 to Chao, which is herein incorporated by reference in its entirety, describes a process for depositing a metal layer on the surface of a polycarbonate-ABS resin (or other similar resin) comprising the steps of contacting the surface with an aqueous metal hydroxide solution, contacting the surface with an aqueous alkaline solution of a water-soluble permanganate, removing any residue of manganese compounds by contact with a reducing agent, and depositing an electroless metal layer on the surface. The alkaline permanganate generally comprises sodium or potassium permanganate and the reducing agent may comprise, for example, a solution of hydroxylamine salts.

Permanganate solutions are described for example in U.S. Pat. No. 3,625,758 to Stahl et al., which is herein incorporated by reference in its entirety. Stahl et al. suggests that the use of either a chrome and sulfuric acid bath or a permanganate solution may be suitable for preparing the surface.

Those attempting to use permanganate for etching plastics other than epoxy base printed circuit boards have not had much success. First, the surface treatment of the plastic sometimes yields good adhesion and sometimes yields poor adhesion under identical treatment conditions. Second, permanganate solutions can be unstable, have a short life and rapidly decomposed to manganese dioxide. Furthermore, as compared to chrome etchants, permanganate is less effective and not suitable for the wide range of plastic mixtures plated in general metal finishing operations.

Other attempts to replace the chrome etching are also described in the prior art. For example, U.S. Pat. Nos. 4,941,940, 5,015,329, and 5,049,230, all to Patel et al., which are herein incorporated by reference in their entirety, describe a single or multi-step process for preswelling and etching of functionalized polymers, such as polycarbonates, using an etching solution that comprises at least one swelling agent and at least one degradation agent. The prepared substrates are then plated with electroless nickel or electroless copper.

U.S. Pat. No. 5,160,600 to Patel et al., which is herein incorporated by reference in its entirety, replaces the chromic acid etching solution with an etching solution that comprises sulfuric acid, and optionally phosphoric acid and/or nitric acid. The treated substrate is then immersed in an aqueous suspension of palladium.

WO 02/095091 to Atotech Deutschland GMBH, which is herein incorporated by reference in its entirety, skips the electroless metallization step used in much of the prior art and provides a process for the direct metallization of non-conductive substrates, especially the metallization of printed circuit boards. WO 02/095091 describes a direct metallization process comprising the steps of (1) bringing the substrate into contact with a water soluble polymer, (2) treating the substrate with a permanganate solution to form a layer of manganese dioxide, (3) treating the substrate with an acidic aqueous solution or an acidic microemulsion of aqueous base containing at least one thiophene compound and at least one alkane sulfonic acid to create a conductive polymer layer, and (4) electrolytically metalizing the substrate.

U.S. Pat. No. 5,575,898 to Wolf et al., which is herein incorporated by reference in its entirety, also describes direct electrolytic plating of a nonconductive substrate and, in particular, teaches through-hole plating of printed circuit boards by applying a conductive layer of polythiophene onto the walls of the through-holes and then electrodepositing copper onto the walls of the through-holes. Prior to treating the substrate with the thiophene composition, the substrate is treated with a potassium permanganate solution.

As is apparent, while a number of processes have been suggested for replacing chromic acid etchants, none have proven completely satisfactory for various economic, performance, and/or environmental reasons. Thus, there exists a need in the art for an improved process for preparing a non-conductive surface for electrolytic metallization.

Regardless of whether the oxidant solution is a hexavalent chromium solution or a permanganate solution, contact with the solution leaves an oxidant residue on the surface of the plastic part that acts to poison the catalytic surface, interfering with metal deposition and often resulting in void formation. A simple water rinse is generally inadequate to remove the residue and the art has resorted to a further step of contact with a solution of a reducing agent although more chemistry is involved in removal of oxidant residue than simple reduction. Removal of permanganate residue with a reducing agent is disclosed in above referenced U.S. Pat. Nos. 4,610,895 to Tubergen et al. and 6,645,557 to Joshi.

Thus, as is readily seen, many etching solutions have been suggested as a replacement for chromic acid in processes for preparing non-conductive substrates for metalization. However, none of these processes has achieved commercial success or has been accepted by the industry as a suitable replacement for chromic acid etching.

The inventor has discovered that an aqueous solution of an alkali metal permanganate and acid, preferably phosphoric acid, with the balance water can achieve a result that is similar to chromic acid etching and that can used to prepare most plastics for subsequent electrolytic metallization.

Another key step in the process of preparing non-conductive substrates for subsequent metallization is an activation step, which generally comprises contacting the etched substrate with a suitable activation solution, which generally comprises palladium.

Palladium activator solutions are typically supplied as liquid concentrates and typically contain a palladium colloid with tin in a hydrochloric acid liquid base. An alternative activator solution containing an ionic palladium supplied in a sulfuric acid base. Manufacturing of the colloid is demanding and is considered somewhat of an art. In both instances, there can be problems with product shipping and storage. Palladium activators are described, for example, in U.S. Pat. No. 5,229,169 to Chao, U.S. Pat. No. 5,648,125 to Cane, and U.S. Pat. No. 4,042,729 to Polichette et al., which are herein incorporated by reference in their entirety.

One of the main concerns with liquid activators is the possibility of leakage. A damaged or leaking container can spill high cost palladium that is un-recoverable as a product. Further, leaking hydrochloric or sulfuric acid may cause a dangerous chemical spill. These problems are particularly concerning during air transport of product. Thus, transporting activators requires that small individual containers be shipped and that the containers be thoroughly packaged.

In addition, colloidal palladium activators can become unstable over time resulting in precipitation of palladium, which in turn causes the activator to become ineffective. The colloid may similarly become unstable if air agitation is used to mix the solution or if the activator is spray applied, because air readily oxidizes tin which results in collapse of the colloid.

The inventor has surprisingly discovered a novel activator composition usable in the process of the invention that contains a palladium salt and an amine complexor. A key benefit to the activator of the invention is that activator can be prepared as a dry powder and then mixed with water (or solvent) just before use. Thus, the activator is not subject to the storage and shipping issues that are of concern with liquid activator concentrates and the dry activator powder also remains more stable over time. Furthermore, manufacturing the dry activator powder is easy and straightforward, thus substantially reducing both manufacturing difficulty and product variability.

The novel process developed by the inventor of this application achieves similar results to chromic acid etchants of the prior art yet uses a more environmentally friendly permanganate etchant and a more stable palladium activator. The process of the invention can be used to treat most if not all types of non-conductive substrates that are currently treated using chrome with the same result and can advantageously fit into existing process lines with little or no additional costs.

### SUMMARY OF THE INVENTION

The method of the invention generally comprises plating a non-conductive substrate in a process comprising the steps of:
a) etching a surface of the non-conductive substrate with an etching solution, said etching solution comprising a permanganate and a mineral acid (preferably phosphoric acid);
b) activating the etched surface of the non-conductive substrate with an activating solution comprising a palladium salt and an amine complexor;
c) contacting the etched and activated surface of the non-conductive substrate with a reducing agent to reduce the palladium salt to metal; and
d) electrolessly plating the etched and activated surface.

### DETAILED DESCRIPTION OF THE PREFERRED EMBODIMENTS OF THE INVENTION

The novel etching composition of the invention uses a permanganate mixed with a mineral acid, such as preferably phosphoric acid, as a replacement for the hexavalent chrome etching solution of the prior art.

Although phosphoric acid is the preferred mineral acid, the invention is not limited to phosphoric acid. Other acids, such as sulfuric acid and boric acid, that are compatible with the alkali permanganate are also acceptable. In addition, the pH of the etching solution can range from acid to alkaline but is preferably acidic, although a pH within the range of about 1 to about 3 is most preferred.

Various salts of permanganate are usable in the invention, including potassium, sodium, lithium, and ammonium. Because of both cost and availability, potassium permanganate is the preferred salt for use in the invention. The maximum useful concentration of the salt of permanganate in the solution is the saturation point of the particular salt. For example, the saturation point for potassium permanganate is about 70 g/l. The inventor has also found that the low effective concentration (for potassium permanganate) is about 20 g/l.

The temperature at which the etching composition is operated has an effect on the immersion time required. Higher operating temperatures can hasten the reduction (destabilization) of permanganate, while lower temperatures can extend the required immersion time.

It is preferred that the manganese oxide film that is deposited on the polymer substrate remain on the substrate throughout subsequent processing steps. The inventor has surprisingly found that the manganese oxide film that is formed on the surface enhances activation. In contrast, it is believed that prior art processes using potassium permanganate require that the manganese oxide film that is formed during the etching step be stripped (or reduced) from the surface prior to the activation step.

The inventor has also surprisingly found that traditional palladium/tin colloid activators described in the prior art are preferably not be used in this invention because the high hydrochloric acid content of traditional palladium activator solutions dissolves the manganese oxide film that is deposited, yielding poor plating.

Instead, the present invention preferably uses a non-tin palladium activator comprised of palladium sulfate and a suitable amine complexor, such as 2-amino pyridine. The composition generally comprises about 50 mg/l of palladium as sulfate and 1-3 molar equivalents of palladium to the amine complexor.

In a preferred embodiment, the activator of the present invention mixes a palladium sulfate solution (containing about 12% Pd) with the amine complexor (such as, 2-amino pyridine) at a molar ratio between about 1:1 to about 1:3, preferably about a 1:1.5 molar ratio. The solution is then mixed with boric acid so that a final concentration of about 50 mg Pd per 10 g of boric acid is achieved. The activator mixture is a powder.

The dry activator is made-up for use by dissolving about 10 g of the activator powder in 1 liter of water. The solution pH is adjusted to 13-14 using caustic. After allowing the solution to mix for a minimum of about one hour, the pH is adjusted to 5-13 using acid. Heating the activator to 100-212° F. improves efficacy.

An amine complex is believed to form with palladium at a pH of about 13. At this pH, the complexed palladium is completely soluble. At a pH between 3 and 13, the palladium complex slowly precipitates. The final activator solution is a suspension of palladium 2-amino pyridine solid or possibly, oligomers thereof.

The activator solution is preferably used at a temperature of about 100° F., but the solution may also be usable at any effective temperature from freezing to boiling. The preferred pH of the activator solution is 8, but the activator may also be usable at any effective pH between about 1 and 14.

Although the activator solution is described as containing palladium sulfate, other salts of palladium are also be usable in the invention. In addition, other palladium complexes (amine or other) are also contemplated by the inventor of the present invention. Other caustic salts can be used.

The novel activator of the invention is not generally susceptible to colloidal failure. Thus, air agitation and/or spray application do not cause problems. The novel activator of the invention can preferably be run at a pH between about 4 and 12, adjusted with sulfuric acid or caustic solutions, depending on the desired pH.

The normal tin accelerating step of the prior art is replaced with an accelerator that comprises 1-2 g/l sodium borohydride in caustic solution. The borohydride acts to reduce the palladium salt to palladium metal. Other reducing agents, such as hypophosphites, hydrazine, and amine boranes are also usable in the invention.

The preferred process conditions and concentrations are described below:

1) Surface preparation of the polymer substrate by contacting the polymer substrate with a permanganate etch solution comprising:

Composition

| | |
|---|---|
| 45%/v | mineral acid such as phosphoric acid; |
| 50 g/l | permanganate salt such as potassium permanganate; |
| Balance | water |

Operating conditions:

| | |
|---|---|
| Temperature: | 100° F. |
| Time: | 5 minute immersion for ABS plastics |
| | 15 minute immersion for Polycarbonate/ABS blends. |

Times and or concentrations can be altered as needed to prepare other plastics such as polypropylene and nylon.

2) Activating the etched polymer substrate by contacting the substrate with a palladium composition comprising:

Composition:

| | |
|---|---|
| 50 mg/l | palladium salt such as palladium as sulfate; and |
| 50-150 mg/l | amino complexing agent such as 2-amino pyridine. |

Operating conditions:

| | |
|---|---|
| pH: | 11.5, adjusted with caustic |
| Temperature: | 100° F. |
| Time: | 3 minute immersion |

3) Reducing the palladium salt by contacting the substrate with a reducing agent comprising a borohydride solution comprising:

Composition:

| | |
|---|---|
| 2 g/l | palladium reducing agent such as sodium borohydride; and |
| 4 g/l | caustic |

Operating conditions:

| | |
|---|---|
| Temperature: | 100° F. |
| Time: | 2 minute immersion. |

4) Contacting the substrate with an electroless nickel plating solution such as Macuplex 808 (available from MacDermid, Incorporated of Waterbury, Conn.) or electroless copper.

Operating conditions:

| | |
|---|---|
| pH: | 6.5 |
| Temperature: | 100° F. |
| Time: | 12 minute immersion |

5) Plating the substrate with electrolytic copper, nickel or chrome, as specified.

The above steps are advantageously carried out with one or more steps of rinsing, preferably with deionized water, after every step.

The invention is not limited to electroless nickel plating, and depending on the process, any metal that can be electrolessly plated is usable in the invention, including, for example, copper, cobalt, silver, and gold.

The process is applicable for the metallization of a variety of non-conductive polymer substrates including, for example, acrylonitrile butadiene styrene (ABS), acrylonitrile butadiene styrene/polycarbonate (ABS/PC), polyamide (PA), polypropylene (PP), thermoplastic olefins (TPO's), polyphenyleneoxide (PPO), polyphenylene ether, polyimides, polyether imide (PEI), polyether ether ketone (PEEK), polyphenylene sulfide, polyphthalamide, polyurethane (PU) and its blends as well as composites such as epoxy-glass laminates. Other suitable non-conducting substrates such as ceramic materials may also be suitably selected by those of skill in the art.

A further benefit of the novel process of the invention is that it solves problems associated with the entrapment and subsequent diffusion of oxidant and residue from capillaries associated with racks that are used to carry the plastic parts through the plating sequence. These racks are often metal coated with a plastisol to resist plating. The ends of the racks are stripped of the plastisol coating to expose the metal and hold the plastic part on the rack. The exposed metal acts as the cathodic contact for a subsequent electroplating step. In this way, following electroless metal plating, the part may be electroplated without reracking because the metal contact holding the part acts as the electrode. The difficulty associated with the use of these racks is that capillary action draws oxidant solution into the interstices between the exposed metal and its plastisol coating. During the plating sequence, oxidant solution and residue diffuse from these interstices poisoning the plastic surface adjacent the point of contact with the rack. This often results in the formation of a void, which acts as an electrical barrier between the rack at its point of contact with the plastic part and the metal plate that interferes with electroplating of the part or causes other related difficulties. Void formation may result in rejection of from about 1 to 15 percent of the plated parts where racks and contacts are used as described.

The invention will now be described by reference to the following non-limiting examples:

### EXAMPLE 1

An ABS panel was plated using the preferred formulation described above. The result was a very bright even plate and a one inch linear pull strength of 10-15 pounds. A control panel was plated using a typical chrome etch cycle and yielded a less bright plate and a pull strength of 8-10 pounds.

### EXAMPLE 2

An ABS/PC blend panel was plated using the preferred formulation described above. The result was a very bright even plate and a one-inch linear pull strength of 5 pounds. A control panel was plated using a typical chrome etch cycle and yielded a less bright plate and a pull strength of 5 pounds.

### EXAMPLE 3

An ABS panel was plated using the preferred formulation described above, but the manganese film was stripped using hydroxylamine sulfate in hydrochloric acid (common current practice). The result yielded no plating.

### EXAMPLE 4

An ABS panel was plated using the preferred formulation described above, except that a conventional colloidal palladium activator was substituted for the activator of the invention. The result yielded incomplete and poor plating.

1. A method of plating a non-conductive substrate comprising the steps of:
a) etching a surface of the non-conductive substrate with an etching solution, said etching solution comprising permanganate salt and a mineral acid;
b) activating the etched surface of the non-conductive substrate with an activating solution comprising a palladium salt and an amine complexor;
c) contacting the etched and activated surface of the non-conductive substrate with a reducing agent for the palladium; and
d) electrolessly plating the etched and activated surface.

2. The method according to claim 1, wherein the etching solution consists essentially of a permanganate salt and a mineral acid.

3. The method according to claim 1, wherein the etching solution is maintained at a pH of less than about 9.

4. The method according to claim 1, wherein the permanganate is selected from the group consisting of potassium permanganate and sodium permanganate.

5. The method according to claim 1, wherein the permanganate is potassium permanganate.

6. The method according to claim 1, wherein the mineral acid is phosphoric acid.

7. The method according to claim 1, wherein the palladium salt is palladium sulfate.

8. The method according to claim 1, wherein the amine complexor is 2-amino pyridine.

9. The method according to claim 1, wherein manganese oxide formed on the surface of the non-conductive substrate during the etching step is not completely stripped from or reduced on the non-conductive substrate prior to the activating step.

10. The method according to claim 1, wherein the reducing agent comprises sodium borohydride in a caustic solution.

11. The method according to claim 1, wherein the electroless plating solution is selected from the group consisting of electroless nickel and electroless copper solutions.

12. The method according to claim 11, wherein the electroless plating solution is an electroless nickel plating solution that does not contain ammonia.

13. An etching solution for preparing a non-conductive substrate for subsequent metal plating, said etching solution comprising a permanganate and a mineral acid.

14. The etching solution according to claim 13, wherein the permanganate is selected from the group consisting of potassium permanganate and sodium permanganate.

15. The etching solution according to claim 13, wherein the alkali permanganate is potassium permanganate.

16. The etching solution according to claim 13, wherein the mineral acid is phosphoric acid.

17. An activator solution for activating a non-conductive substrate for subsequent metal plating, said activator solution comprising a palladium salt and an amine complexor.

18. An activator solution according to claim 17, wherein the palladium salt is selected from the group consisting of a water soluble palladium compound.

19. An activator solution according to claim 17, wherein the palladium salt is palladium sulfate.

20. An activator solution according to claim 17, wherein the amine complexor is 2-amino pyridine.

21. A composition for etching plastics, said composition comprising a permanganate salt and a mineral acid.

22. A composition according to claim 21 wherein the mineral acid is phosphoric acid.

23. A composition according to claim 21 wherein the pH of the composition is from about 1 to 3.

24. A composition according to claim 22 wherein the pH of the composition is from about 1 to 3.

25. An activator composition comprising a dry mixture of a palladium salt, an amine complexor and a dry acid powder.

26. A composition according to claim 25 wherein the dry acid powder is boric acid.

27. A composition according to claim 25 wherein the amine complexor is 2-amino pyridine.
